(19) United States
(12) Patent Application Publication
(10) Pub. No.: US 2008/0070175 A1
(43) Pub. Date: Mar. 20, 2008

(54) CANDLE INSERT

(75) Inventor: Martin Gerard Marklin, Contoocook, NH (US)

Correspondence Address: SHEEHAN PHINNEY BASS & GREEN, PA;c/o PETER NIEVES, 1000 ELM STREET, MANCHESTER, NH, 03105-3701, US

(73) Assignee: M G Marklin, LLC, Contoocook, NH (US)

(21) Appl. No.: 11/857,591

(22) Filed: Sep. 19, 2007

Related U.S. Application Data
(60) Provisional application No. 60/845,690, filed on Sep. 19, 2006.

(51) Int. Cl. F21V 35/00

(52) U.S. Cl. 431/289

(57) ABSTRACT

A candle insert is provided. Generally, the candle insert contains an elongated tubular member having an internal bore that traverses through a center of the elongated tubular member, where the elongated tubular member has a proximate end and a distal end. The candle insert also contains an enlarged disc-shaped end piece located at the proximate end of the elongated tubular member, where the enlarged disc-shaped end piece contains an indented portion capable of receiving a torque producing tool. The elongated tubular member also contains external threading extending along an outside surface of the elongated tubular member, and internal threading extending inward within the internal bore.

### CROSS-REFERENCE TO RELATED APPLICATIONS

This application claims priority to copending U.S. Provisional Application entitled, “CANDLE INSERT,” having Ser. No. 60/845,690, filed Sep. 19, 2006, which is entirely incorporated herein by reference.

### FIELD OF THE INVENTION

The present invention is generally related to holding devices, and more particularly is related to a candle insert for allowing a candle to be stabilized on a structure.

### BACKGROUND OF THE INVENTION

Individuals, corporations, churches, and other entities commonly use candles. For as many designs as there are for candles, there are also many devices for displaying the candles. One device for displaying candles is a candle stand. Candle stands come in various shapes and sizes, but all are faced with the task of holding a candle.

One example of a candle stand faced with the task of maintaining a candle in an upright position, is a processional standard. A processional standard must not only maintain an attached candle in an upright position, but it must do so while the standard is being carried. As a result, a device used for securing the candle to the standard is required to maintain the connection between the candle and the standard regardless of an angle of tilt of the candle.

Thus, a heretofore unaddressed need exists in the industry to address the aforementioned deficiencies and inadequacies.

### SUMMARY OF THE INVENTION

Embodiments of the present invention provide a candle insert for maintaining a candle in position without falling. Briefly described, in architecture, one embodiment of the candle insert, among others, can be implemented as follows. The candle insert contains an elongated tubular member having an internal bore that traverses through a center of the elongated tubular member, where the elongated tubular member has a proximate end and a distal end. The candle insert also contains an enlarged disc-shaped end piece located at the proximate end of the elongated tubular member, where the enlarged disc-shaped end piece contains an indented portion capable of receiving a torque producing tool. The elongated tubular member also contains external threading extending along an outside surface of the elongated tubular member, and internal threading extending inward within the internal bore.

Other features and advantages of the present invention will be or become apparent to one with skill in the art upon examination of the following drawings and detailed description. It is intended that all such additional features and advantages be included within this description, be within the scope of the present invention, and be protected by the accompanying claims.

### BRIEF DESCRIPTION OF THE DRAWINGS

Many aspects of the invention can be better understood with reference to the following drawing. The components in the drawing are not necessarily to scale, emphasis instead being placed upon clearly illustrating the principles of the present invention. Moreover, in the drawing, like reference numerals designate corresponding parts throughout the view.

FIG. 1 and FIG. 2 are schematic diagrams illustrating a candle insert in accordance with a first exemplary embodiment of the invention.

FIG. 3 further illustrates the distal end of the candle insert of FIG. 1 and FIG. 2.

FIG. 4 and FIG. 5 are cross-sectional views of the candle insert of FIG. 1 and FIG. 2.

### DETAILED DESCRIPTION

The present candle insert is capable of being received by a portion of a candle and is also capable of receiving a threaded rod therein. The candle insert may be fabricated from one or more different materials such as, but not limited to, metal or plastic. In addition, size of the insert may vary in accordance with size of the candle, and size and thread count of the rod that is to be secured to an inner portion of the insert.

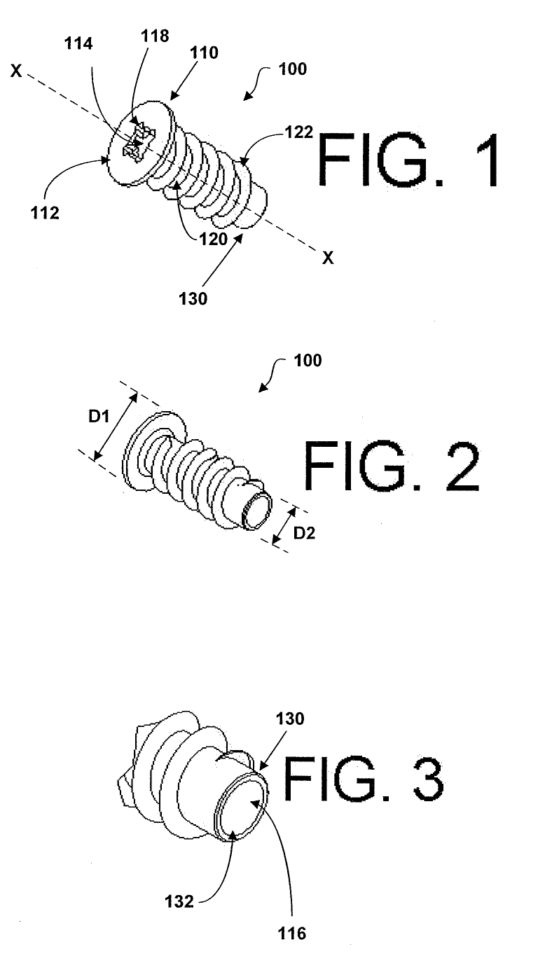

FIG. 1 and FIG. 2 are schematic diagrams illustrating the candle insert 100 in accordance with a first exemplary embodiment of the invention. The candle insert 100 contains a proximate end 110 and a distal end 130. The proximate end 110 of the candle insert 100 contains an enlarged circular end 112 that is in the shape of a flat disc (i.e., disc-shaped), or a washer. The enlarged circular end 112 has an opening 114, which is a first end of an internal bore 116 (FIG. 3) (NEED A CROSS-SECTIONAL VIEW) that traverses through a central axis X-X of the candle insert 100. The enlarged circular end 112 also contains an indented portion 118, which is a torque producing tool receptor opening, that is capable of communicating force, along the central axis of the candle insert 100, with the entire candle insert 100.

The candle insert 100 also contains an elongated tubular member 120. A first end of the elongated tubular member 120 meets the enlarged circular end 112 at approximately ninety degrees. The internal bore 116 traverses through the center of the elongated tubular member 120. It should be noted that the internal bore 116 may or may not have the same diameter throughout the elongated tubular member 120. It should also be noted that a diameter D1 of the enlarged circular end 112 is larger than a diameter D2 of the elongated tubular member 120.

External threading 122 extends along an outside surface of the elongated tubular member 120 from the enlarged circular end 112 to the distal end 130 of the candle insert 100. It should be noted that, in accordance with an alternative embodiment of the invention, the external threading 122 may not extend the entire distance from the enlarged circular end 112 to the distal end 130.

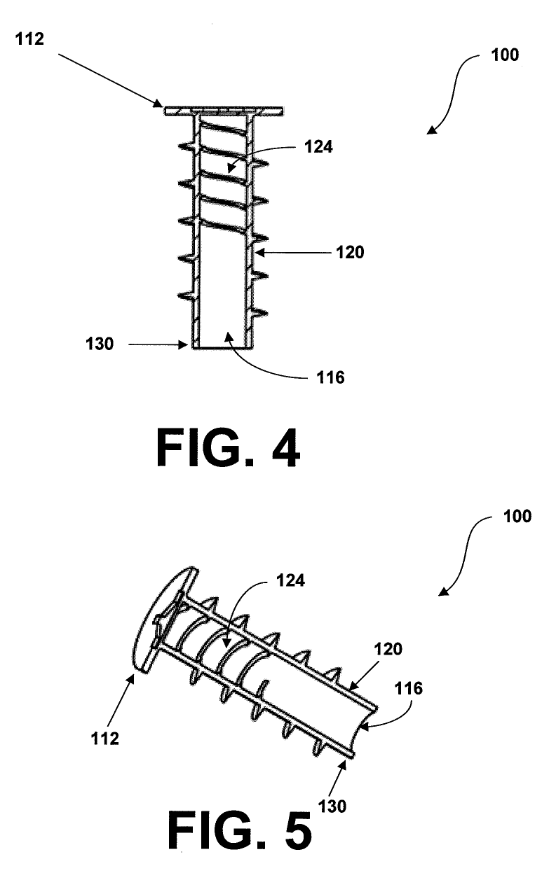

FIG. 4 and FIG. 5 are cross-sectional views of the candle insert 100 of FIG. 1 and FIG. 2. Referring to FIG. 4 and FIG. 5, an internal threading 124 extends inward within the internal bore 116 from the enlarged circular end 112 to approximately half the length of the elongated tubular member 120 toward the distal end 130 of the candle insert 100. It should be noted that, in accordance with an alternative embodiment of the invention, the internal threading 124 may not extend as long as approximately half the length of the elongated tubular member 120, or the internal threading 124 may extend more than approximately half the length of the elongated tubular member 120.

The distal end 130 of the candle insert 100 contains an opening 132 that is a second end of the internal bore 116. It should be noted that the distal end 130 of the candle insert 100 is a second end of the elongated tubular member 120. FIG. 3 further illustrates the distal end 130 of the candle insert 100.

During use of the candle insert 100, the distal end 130 of the candle insert 100 would be inserted into a bottom portion of a candle, while the proximate end 110 of the candle insert 100 would receive a screw from a structure to which the candle is to be secured.

An example of a structure to which the candle screw may be secured is a processional standard. As is known by those having ordinary skill in the art, a processional standard contains an elongated screw that extends from the processional standard. A distal end of the processional standard may be received by the opening 114 located at the proximate end 110 of the candle insert 100. Preferably, the elongated screw of the processional standard is secured to the candle insert after the candle insert has been inserted within the candle, although it is possible to first removably secure the candle screw to the elongated screw of the processional standard.

It should be noted that while the abovementioned refers to connecting the candle insert to the elongated screw of a processional standard the candle insert may instead be connected to a different object having an elongated screw that is capable of being removably connected to the candle insert. As an example, the object may be stationary, such as, but not limited to, a candle stand, where securing the candle insert to the candle stand would prevent movement of the candle.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A candle insert, comprising:
an elongated tubular member having an internal bore that traverses through a center of said elongated tubular member, said elongated tubular member having a proximate end and a distal end;
an enlarged disc-shaped end piece located at said proximate end of said elongated tubular member;
external threading extending along an outside surface of said elongated tubular member; and
internal threading extending inward within said internal bore.

2. The candle insert of claim 1, wherein said enlarged disc-shaped end piece contains an indented portion capable of receiving a torque producing tool.

3. The candle insert of claim 2, wherein said enlarged disc-shaped end piece meets said elongated tubular member at approximately ninety degrees.

4. The candle insert of claim 3, wherein said internal bore has a diameter that is smaller than a diameter of said enlarged disc-shaped end piece.

5. The candle insert of claim 2, wherein said internal threading extends from said enlarged disc-shaped end piece to approximately half a length of said elongated tubular member, toward said distal end of said elongated tubular member.

6. The candle insert of claim 2, wherein said internal bore has does not have the same diameter throughout said elongated tubular member.

7. The candle insert of claim 2, wherein said internal threading extends throughout the entire internal bore.

8. The candle insert of claim 2, wherein said internal threading extends through a portion of the internal bore.

9. The candle insert of claim 2, wherein said candle insert is fabricated from plastic.

10. The candle insert of claim 2, wherein said candle insert is fabricated from metal.
